(19) United States
(12) Patent Application Publication
(10) Pub. No.: US 2017/0259625 A1
(43) Pub. Date: Sep. 14, 2017

(54) Pneumatic Tire Having Sidewall Cover Layer

(71) Applicant: Bridgestone Americas Tire Operations, LLC, Nashville, TN (US)

(72) Inventors: David J. Zemla, Canal Fulton, OH (US); Jon I. Stuckey, Uniontown, OH (US); Robert G. Barned, Akron, OH (US)

(21) Appl. No.: 15/510,721

(22) PCT Filed: Sep. 25, 2015
(86) PCT No.: PCT/US15/52109

§ 371 Date: Mar. 13, 2017

Related U.S. Application Data
(60) Provisional application No. 62/087,003, filed on Dec. 3, 2014.

(51) Int. Cl. B60C 13/04; B60C 1/00

(52) U.S. Cl. CPC B60C 13/04; B60C 1/0025

(57) ABSTRACT

A pneumatic tire having a sidewall cover layer for application of a printing ink and/or paint is provided. In one embodiment, the tire comprises: a sidewall portion including a cushion layer and a cover layer, wherein the cover layer is oriented axially outwardly of the cushion layer, wherein the cover layer is bonded to the cushion layer, wherein the cover layer is formed from a material that contains wax in a concentration of less than 0.03 pph, and wherein the cushion layer does not contain a wax.

### CROSS-REFERENCE TO RELATED APPLICATIONS

### Background

In the manufacture of a vehicle tire, it may be desirable to apply a painted design or wording to at least a portion of the tire's sidewall. For example, one may desire to apply any of a variety of designs or wording to a tire, including for example: a color pattern, an indicia, branding, tire information, a logo, an image, appliqué, and the like. The designs maybe applied to the tire with paints, inks, or the like.

However, it may be difficult to maintain proper adhesion between a traditional paint or ink and a traditional tire sidewall compound. For example, traditional tire sidewall compounds may include waxes that inhibit proper adhesion between the paint or ink and the compound. As a result, designs or wording applied to the tire in such a manner may disbond prematurely, if they ever bond at all.

Additionally, tire sidewall compounds including a wax or an antiozonant may seep through the compound to the surface and discolor applied paints or inks oriented thereon. As a result, wording or designs applied to a tire sidewall wherein the sidewall compound includes a wax and/or an antiozonant may be disrupted, stained, or otherwise ruined by the wax and/or antiozonant.

What is needed is a sidewall cushion layer and cover layer combination that permits application of wording or designs in paint or ink with proper bonding and without degradation by a wax and/or antiozonant.

### SUMMARY

In one embodiment, a tire is provided, the tire comprising: a sidewall portion including a cushion layer and a cover layer, wherein the cover layer is oriented axially outwardly of the cushion layer, wherein the cover layer is bonded to the cushion layer, wherein the cover layer is formed from a material that contains wax in a concentration of less than 0.03 pph, and wherein the cushion layer does not contain a wax.

In another embodiment, a tire is provided, the tire comprising: a sidewall portion including a cushion layer and a cover layer, wherein the cover layer is oriented axially outwardly of the cushion layer, wherein the cover layer is bonded to the cushion layer, wherein the cover layer is a thermoset material, and wherein the cover layer is formed from a material that contains a staining antiozonant in a concentration of less than 0.015 pph.

In another embodiment, a tire is provided, the tire comprising: a sidewall portion including a cushion layer and a cover layer, wherein the cover layer is oriented axially outwardly of the cushion layer, wherein the cover layer is bonded to the cushion layer, wherein the cover layer is formed from a cover layer compound having a variety of polymers, wherein at least a portion of the polymers have an ozone resistant backbone, and wherein the cover layer compound contains a staining antiozonant in a concentration of less than 0.03 pph.

### BRIEF DESCRIPTION OF THE DRAWINGS

The accompanying figures, which are incorporated in and constitute a part of the specification, illustrate various example systems and apparatuses, and are used merely to illustrate various example embodiments. In the figures, like elements bear like reference numerals.

FIG. 1 illustrates a cross-section of a sidewall portion of a tire including a cover layer.

FIG. 2A illustrates a cross-section of a portion of a tire 200 including a cover layer 206.

FIG. 2B illustrates a cross-section of a portion of tire 200 including cover layer 206.

FIG. 3 illustrates a cross-section of a sidewall portion of a tire including a cover layer.

FIG. 4A illustrates a cross-section of a portion of a tire 400 including a cover layer 406.

FIG. 4B illustrates a cross-section of a portion of tire 400 including cover layer 406.

FIG. 4C illustrates a cross-section of a portion of tire 400 including cover layer 406.

### DETAILED DESCRIPTION

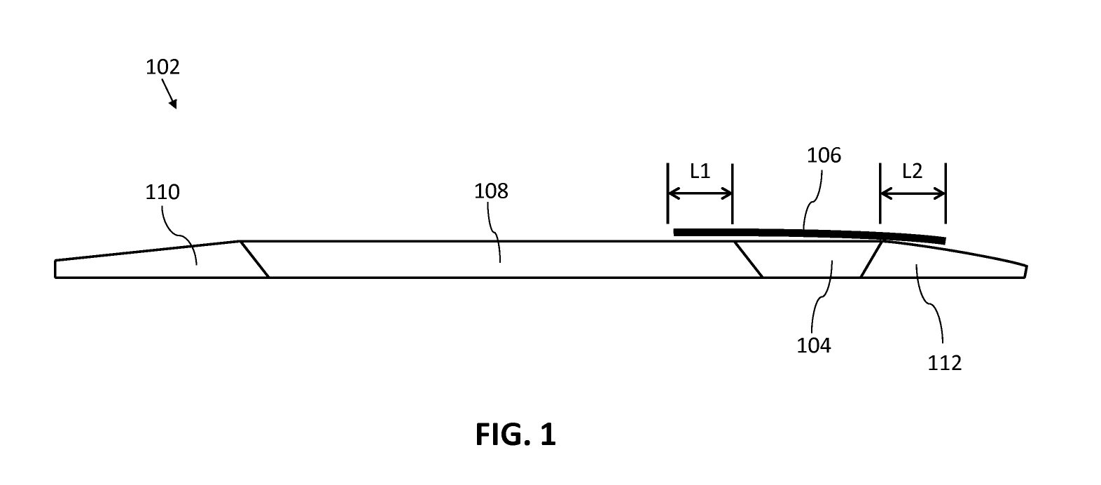

FIG. 1 illustrates a cross-section of a sidewall portion 102 of a tire. Sidewall portion 102 may include a cushion layer 104 and a cover layer 106. Sidewall portion 102 may include a sidewall compound material 108. Sidewall portion 102 may include a belt edge insert 110. Sidewall portion 102 may include an abrasion material 112.

Sidewall portion 102 may be assembled from its various components and applied to a tire carcass at a tire building machine. Alternatively, any of the various components of sidewall portion 102 may be applied to a tire carcass at a tire building machine. At least some of sidewall portion 102 may be formed from its various components via co-extrusion. At least some of sidewall portion 102 may be formed from its various components via co-calendering. At least some of sidewall portion 102 may be formed from its various components via stitching together of the various components. Any of the various components outlined above may be formed via extrusion. Any of the various components outlined above may be formed via calendering.

Cushion layer 104 may be formed from any of a variety of materials, including for example a polymeric material, a rubber, a composite, and the like. Cushion layer 104 may be formed from a material that contains no wax. Cushion layer 104 may be formed from a material that contains wax in a concentration of less than about 5 pph. Cushion layer 104 may be formed from a material that contains no antiozonant. Cushion layer 104 may be formed from a material that contains antiozonant in a concentration of less than about 5 pph. Cushion layer 104 may be formed from a non-staining polymer material. Cushion layer 104 may be formed from a material that contains no staining antiozonant. Cushion layer 104 may be formed from a material that contains staining antiozonant in a concentration of less than about 0.10 pph. Cushion layer 104 may be formed from a material that contains staining antiozonant in a concentration of less than about 0.05 pph. Cushion layer 104 may be formed from a material that contains staining antiozonant in a concentration of less than about 0.03 pph. Cushion layer 104 may be formed from a material that contains staining antiozonant in a concentration of less than about 0.015 pph. Cushion layer 104 may be formed from a material that contains only trace amounts of staining antiozonant. Cushion layer 104 may be formed from a material that has non-staining antiozonant.

Cushion layer 104 may be oriented on both sides of a tire. Cushion layer 104 may be oriented on only an outboard side of a tire. Cushion layer 104 may be oriented on only an inboard side of a tire. Cushion layer 104 may be oriented in any part of sidewall portion 102. Cushion layer 104 may be oriented in a lower sidewall region of sidewall portion 102. Cushion layer 104 may be oriented in an upper sidewall region of sidewall portion 102. Cushion layer 104 may be oriented in a central region of sidewall portion 102. A plurality of cushion layers 104 may be oriented in sidewall portion 102.

Cover layer 106 may be formed from any of a variety of materials, including for example a polymeric material, a rubber, a composite, and the like. Cover layer 106 may be formed from a material that contains no wax. Cover layer 106 may be formed from a material that contains wax in a concentration of less than 0.1 pph. Cover layer 106 may be formed from a material that contains wax in a concentration of less than 0.05 pph. Cover layer 106 may be formed from a material that contains wax in a concentration of less than 0.03 pph. Cover layer 106 may be formed from a material that contains wax in a concentration of less than 0.015 pph. Cover layer 106 may be formed from a material that contains only trace amounts of wax. Cover layer 106 may be formed from a material that contains no antiozonant. Cover layer 106 may be formed from a material that contains antiozonant in a concentration of less than 5 pph. Cover layer 106 may be formed from a non-staining polymer material. Cover layer 106 may be formed from a material that contains no staining antiozonant. Cover layer 106 may be formed from a material that contains staining antiozonant in a concentration of less than 0.1 pph. Cover layer 106 may be formed from a material that contains staining antiozonant in a concentration of less than 0.05 pph. Cover layer 106 may be formed from a material that contains staining antiozonant in a concentration of less than 0.03 pph. Cover layer 106 may be formed from a material that contains staining antiozonant in a concentration of less than 0.015 pph. Cover layer 106 may be formed from a material that contains only trace amounts of staining antiozonant. Cover layer 106 may be formed from a material that has non-staining antiozonant. Cover layer 106 may be formed using a material having a backbone polymer that is ozone resistant. Cover layer 106 may be formed from a material that is ozone resistant, but that does not contain wax or antiozonant. Cover lay 106 may be formed from a thermoset material.

Cover layer 106 may be formed from a cover layer compound having a variety of polymers. At least a portion of the polymers of the cover layer compound may have an ozone resistant backbone. About 50% of the polymers of the cover layer compound may have an ozone resistant backbone. Between about 30% and about 70% of the polymers of the cover layer compound may have an ozone resistant backbone. Between about 40% and about 60% of the polymers of the cover layer compound may have an ozone resistant backbone. The cover layer compound may contain staining antiozonant in only trace amounts. The cover layer compound may contain staining antiozonant in a concentration of less than 0.03 pph. The cover layer compound may contain staining antiozonant in a concentration of less than 0.015 pph.

Cover layer 106 may be oriented on both sides of a tire. Cover layer 106 may be oriented on only an outboard side of a tire. Cover layer 106 may be oriented on only an inboard side of a tire. Cover layer 106 may be oriented in any part of sidewall portion 102. Cover layer 106 may be oriented in a lower sidewall region of sidewall portion 102. Cover layer 106 may be oriented in an upper sidewall region of sidewall portion 102. Cover layer 106 may be oriented in a central region of sidewall portion 102. A plurality of cover layers 106 may be oriented in sidewall portion 102.

Cover layer 106 may be applied over cushion layer 104. Cover layer 106 may be laminated upon cushion layer 104. Cover layer 106 may be calendered over cushion layer 104. Cover layer 106 may be applied to cushion layer 104 when both cover layer 106 and cushion layer 104 are uncured, after which the two may be cured. Cover layer 106 may be applied to cushion layer 104 when cover layer 106 is uncured and cushion layer 104 is cured, after which the two may undergo curing together. Cover layer 106 may be applied to cushion layer 104 and bonded to cushion layer with an adhesive.

Cover layer 106 may extend radially past cushion layer 104 on at least one side. Cover layer 106 may extend past cushion layer 104 on a first side by a distance L1. Distance L1 may be any distance. For instance, distance L1 may be about 6.4 mm. Distance L1 may be between about 0.0 mm and about 12.7 mm. Distance L1 may be between about 3.2 mm and about 9.5 mm. The first side may be oriented nearer the tire's tread (not shown) in the finished product. Distance L1 may include a range utilizing the upper and lower limits of any ranges, or exact values, disclosed herein.

Cover layer 106 may extend radially past cushion layer 104 on a second side by a distance L2. Distance L2 may be any distance. For instance, distance L2 may be about 6.4 mm. Distance L2 may be between about 0.0 mm and about 12.7 mm. Distance L2 may be between about 3.2 mm and about 9.5 mm. The second side may be oriented nearer the tire's bead (not shown) in the finished product. Distance L2 may include a range utilizing the upper and lower limits of any ranges, or exact values, disclosed herein.

Cover layer 106 may extend radially past cushion layer 104 a distance L1 and L2 so as to prevent exposure of cushion layer 104 to the atmosphere. That is, cushion layer 104 may be degraded if exposed to the atmosphere, and cover layer 106 may be oriented so as to “seal” cushion layer 104 off from the atmosphere. Cover layer 106 may be substantially impervious to atmospheric gases, including for example, air, oxygen, nitrogen, argon, carbon dioxide, and the like. Cover layer 106 may be impervious to atmospheric gases, including for example, air, oxygen, nitrogen, argon, carbon dioxide, and the like.

Cover layer 106 may extend along sidewall portion 102 in any area and does not fall within a splice between any two other materials (whether the materials are the same materials or different materials). That is, in one embodiment, no portion of cover layer 106 may extend between any two other materials at the site of a splice of the two other materials. Orientation of cover layer 106 within a splice between two materials may cause delamination of the two materials as the materials may not properly bond with cover layer 106 in the splice.

Cover layer 106 may have a gauge of about 0.5 mm. Cover layer 106 may have a gauge of about 1.0 mm. Cover layer 106 may have a gauge of less than about 0.5 mm. Cover layer 106 may have a gauge of less than about 1.0 mm. Cover layer 106 may have a gauge greater than about 1.0 mm. Cover layer 106 may have a gauge of greater than about 0.5 mm.

A printing ink and/or paint may be applied to at least a portion of cover layer 106. The printing ink may be a UV-cured ink, such that the ink cures upon exposure to a UV light. The printing ink may be any of a variety of common inks. The printing ink and/or paint may be specifically formulated for bonding to a polymeric material, rubber material, or the like. The printing ink and/or paint may be applied to cover layer 106 following curing of cover layer 106. The printing ink and/or paint may be applied to cover layer 106 prior to curing of cover layer 106. The printing ink and/or paint may be applied to cover layer 106 during curing of cover layer 106.

In one embodiment, no design and/or wording, including printing ink and/or paint, is applied to cover layer 106. Cover layer 106 may be dyed through its entirety, and the dyed cover layer 106 may act as a design and/or wording. In one embodiment, cover layer 106 may include labels. Cover layer 106 may include stickers. Cover layer 106 may include any ornamentation. Cover layer 106 may include any coating.

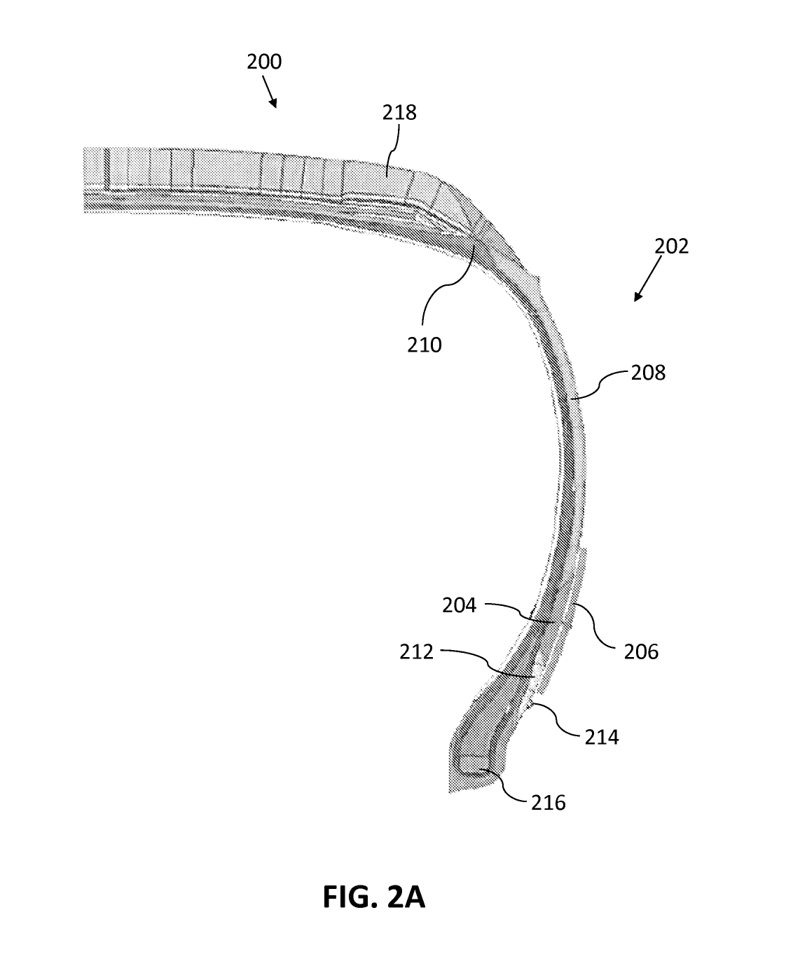

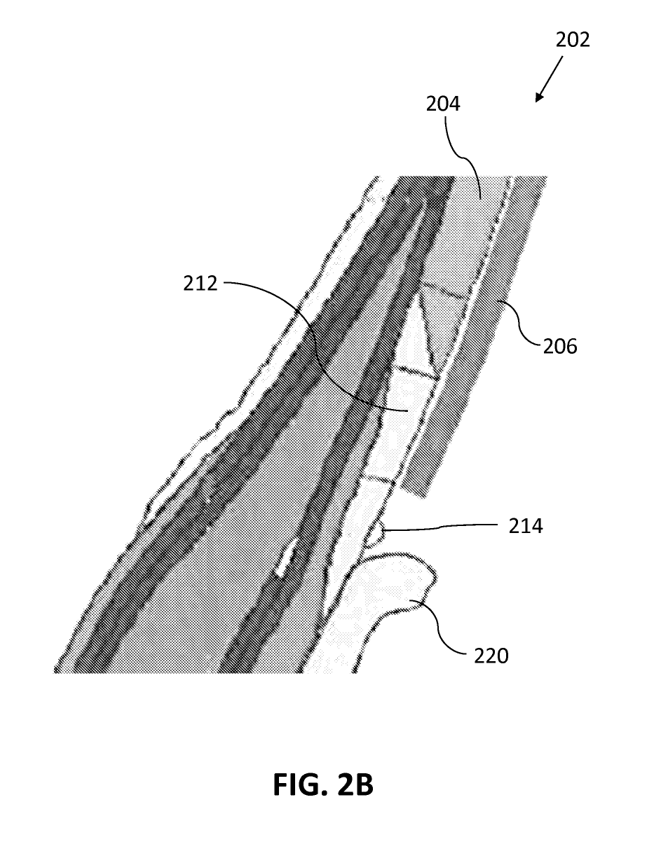

FIG. 2A illustrates a cross-section of a portion of a tire 200. Tire 200 may include a sidewall portion 202. Sidewall portion 202 may include a cushion layer 204 and a cover layer 206. Sidewall portion 202 may include a sidewall compound material 208. Sidewall portion 202 may include a belt edge insert 210. Sidewall portion 202 may include an abrasion material 212. Tire 200 may include a rim centering ring 214 oriented in the lower sidewall region. Tire 200 may include a bead 216. Tire 200 may include a tread portion 218.

Each of the various elements illustrated in FIG. 2A may be substantially similar to those described above in FIG. 1.

Rim centering ring 214 may be oriented at a specified distance from bead 216 in the lower sidewall region. Rim centering ring 214 may be utilized to assist in ensuring concentricity between the tire and a rim (not shown). Cover layer 206 may terminate radially outwardly from rim centering ring 214. Cover layer 206 may terminate at or near rim centering ring 214.

Belt edge insert 210 may be oriented radially inwardly of tread portion 218.

As illustrated, cover layer 206 and cushion layer 204 may be oriented in the lower sidewall region of tire 200. The lower sidewall portion of tire 200 may be defined, in one embodiment, as the radially inner half of sidewall portion 202. Cover layer 206 and cushion layer 204 may be oriented in the radially inner half of sidewall portion 202. Cover layer 206 and cushion layer 204 may be oriented exclusively in the lower sidewall portion of tire 200. A design or wording applied to cover layer 206 may thus be oriented in the lower sidewall region of tire 200. As illustrated, cover layer 206 may be oriented axially outwardly from the centerline of the tire relative to cushion layer 204. Cover layer 206 may be oriented in a layer, axially outwardly relative to other components of the tire, including for example sidewall compound material 208, abrasion material 212, and the like.

FIG. 2A illustrates a “tread-over-sidewall” embodiment, wherein tread 218 has a shoulder element that overlaps (that is, is oriented radially and axially outward relative to) sidewall portion 202 and/or sidewall compound material 208. In some embodiments, referred to herein as “sidewall-over-tread” embodiments, sidewall portion 202 and/or sidewall compound material 208 overlap tread 218 including any shoulder element associated with tread 218.

FIG. 2B illustrates a cross-section of a portion of tire 200 including cover layer 206. Tire 200 may be mounted on a rim having a flange 220. As illustrated, cover layer 206 may be oriented radially outwardly of rim centering ring 214 and flange 220. Abrasion material may be oriented axially inwardly of at least one of rim centering ring 214 and flange 220.

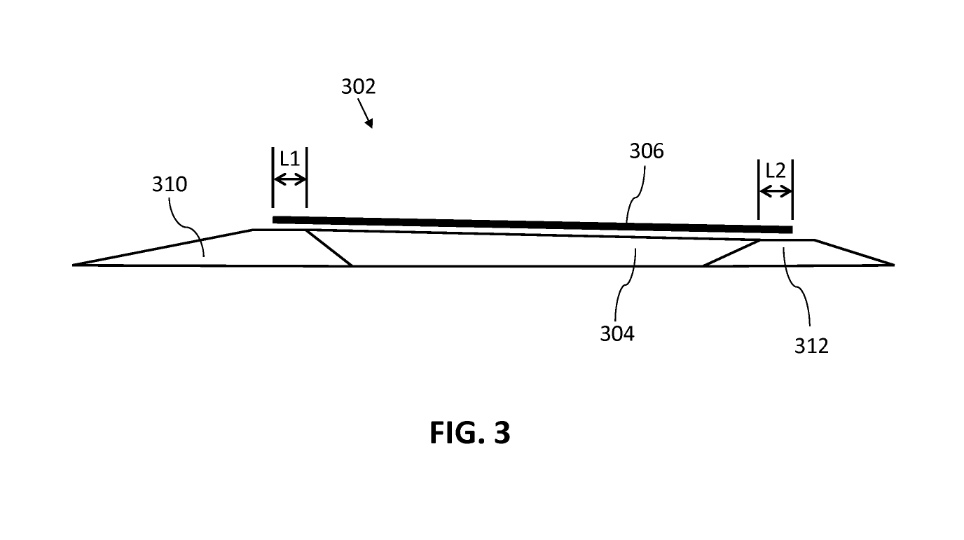

FIG. 3 illustrates a cross-section of a sidewall portion 302 of a tire. Sidewall portion 302 may include a cushion layer 304 and a cover layer 306. Sidewall portion 302 may include a belt edge insert 310. Sidewall portion 302 may include an abrasion material 312. The various components illustrated in FIG. 3 may have the same or similar arrangement as those discussed above with respect to FIG. 1.

Cushion 304 may be oriented along the majority of sidewall portion 302. Cushion 304 may be oriented along at least 60% of the length of sidewall portion 302.

Cover layer 306 may extend along sidewall portion 302 in any area but does not fall within a splice between any two other materials (whether the materials are the same materials or different materials). That is, in one embodiment, no portion of cover layer 306 may extend between any two other materials at the site of a splice of the two other materials. Orientation of cover layer 306 within a splice between two materials may cause delamination of the two materials.

Cover layer 306 may be oriented about the majority of sidewall portion 302. Cover layer 306 may be oriented about at least 60% of the length of sidewall portion 302. Cover layer 306 may be oriented about at least 70% of the length of sidewall portion 302. Cover layer 306 may be oriented about 100% of the length of sidewall portion 302. Cover layer 306 may be oriented about greater than 100% of the length of sidewall portion 302. Cover layer 306 may be oriented about 110% of the length of sidewall portion 302. Cover layer 306 may be oriented about 120% of the length of sidewall portion 302.

Where a tire is formed in a sidewall-over-tread embodiment, cover layer 306 may extend about 100% of the length of sidewall portion 302. Where a tire is formed in a tread-over-sidewall embodiment, cover layer 306 may extend less than 100% of the length of sidewall portion 302, or up until sidewall portion 302 underlaps another material (e.g., at a splice with another material, for example a tread portion).

Cover layer 306 may extend radially past cushion layer 304 on at least one side. Cover layer 306 may extend past cushion layer 304 on a first side by a distance L1. Distance L1 may be any distance. For instance, distance L1 may be about 9.5 mm. Distance L1 may be between about 0.0 mm and about 15.9 mm. Distance L1 may be between about 4.8 mm and about 12.7 mm. The first side may be oriented nearer the tire's tread (not shown) in the finished product. Distance L1 may include a range utilizing the upper and lower limits of any ranges, or exact values, disclosed herein.

Cover layer 306 may extend radially past cushion layer 304 on a second side by a distance L2. Distance L2 may be any distance. For instance, distance L2 may be about 6.4 mm. Distance L2 may be between about 0.0 mm and about 12.7 mm. Distance L2 may be between about 3.2 mm and about 9.5 mm. The second side may be oriented nearer the tire's bead (not shown) in the finished product. Distance L2 may include a range utilizing the upper and lower limits of any ranges, or exact values, disclosed herein.

Cover layer 306 may extend radially past cushion layer 304 a distance L1 and L2 so as to prevent exposure of cushion layer 304 to the atmosphere. That is, cushion layer 304 may be degraded if exposed to the atmosphere, and cover layer 306 may be oriented so as to “seal” cushion layer 304 off from the atmosphere. Cover layer 306 may be substantially impervious or completely impervious to atmospheric gases as described above with respect to FIG. 1.

Cover layer 306 may extend along sidewall portion 302 in any area but does not fall within a splice between any two other materials (whether the materials are the same materials or different materials). That is, in one embodiment, no portion of cover layer 306 may extend between any two other materials at the site of a splice of the two other materials. Orientation of cover layer 306 within a splice between two materials may cause delamination of the two materials.

Cover layer 306 may have a gauge of about 0.5 mm. Cover layer 306 may have a gauge of about 1.0 mm. Cover layer 306 may have a gauge of less than about 0.5 mm. Cover layer 306 may have a gauge of less than about 1.0 mm. Cover layer 306 may have a gauge greater than about 1.0 mm. Cover layer 306 may have a gauge greater than about 0.5 mm.

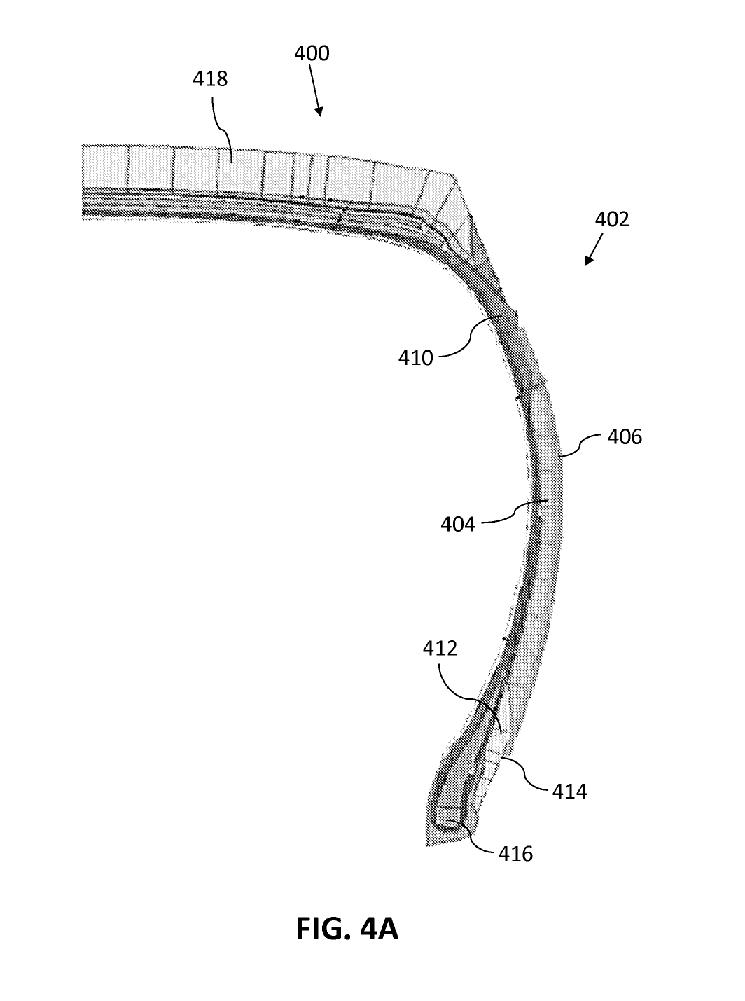

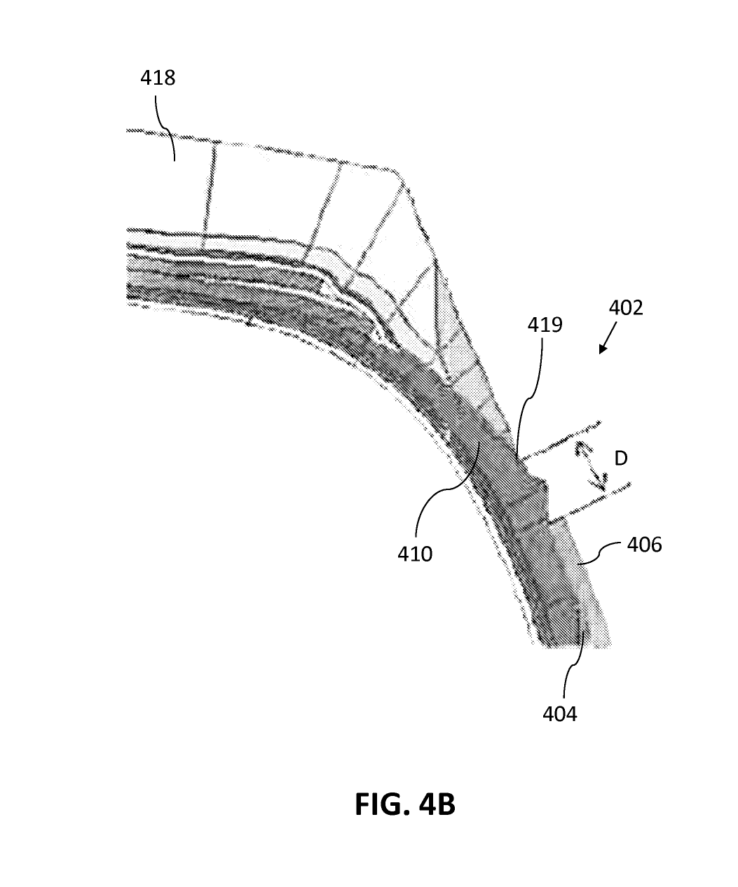

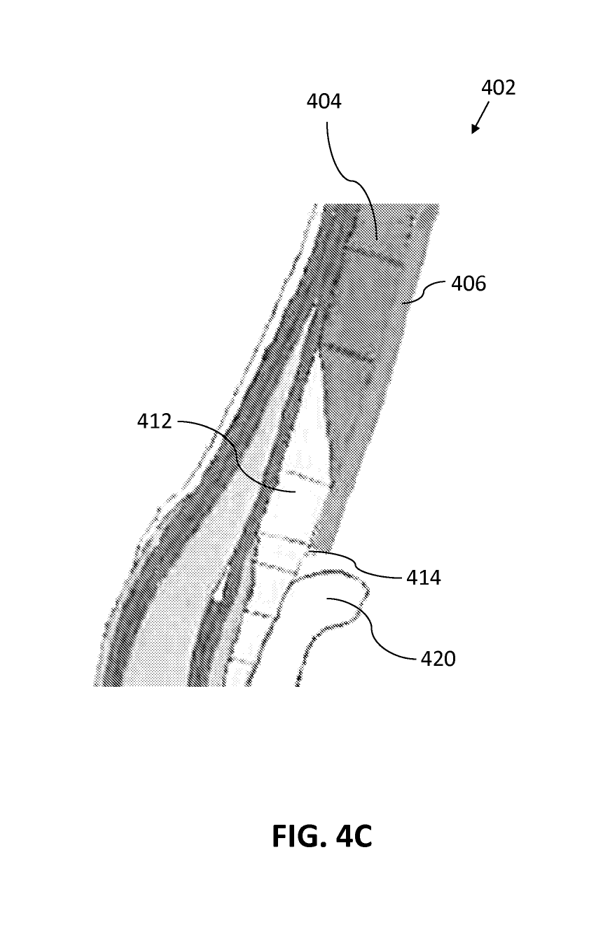

FIG. 4A illustrates a cross-section of a portion of a tire 400. Tire 400 may include a sidewall portion 402. Sidewall portion 402 may include a cushion layer 404 and a cover layer 406. Sidewall portion 402 may include a belt edge insert 410. Sidewall portion 402 may include an abrasion material 412. Tire 400 may include a rim centering ring 414 oriented in the lower sidewall region. Tire 400 may include a bead 416. Tire 400 may include a tread portion 418.

Each of the various elements illustrated in FIG. 4A may be substantially similar to those described above in FIG. 1.

Cover layer 406 may extend radially inwardly to about the same position as rim centering ring 414. Cover layer 406 may terminate radially outwardly of rim centering ring 414. Cover layer 406 may terminate radially inwardly of rim centering ring 414.

FIG. 4A illustrates a “tread-over-sidewall” embodiment, wherein tread 418 has a shoulder element that overlaps (that is, is oriented radially and axially outward relative to) sidewall portion 402 and belt edge insert 410. In some embodiments, referred to herein as “sidewall-over-tread” embodiments, sidewall portion 402 overlaps tread 418 including any shoulder element associated with tread 418.

FIG. 4B illustrates a cross-section of a portion of tire 400. Tread portion 418 may include an axially outermost portion referred to as a tread edge 419. Cover layer 406 may terminate radially inwardly of tread edge 419. Cover layer 406 may terminate radially inwardly by a distance D. Distance D may be any distance. Distance D may be greater than or equal to 0.0 mm. Distance D may be about 9.5 mm. Distance D may be between about 0.0 mm and about 38.0 mm. Distance D may be between about 1.0 mm and about 15.0 mm. Alternatively, distance D may have a negative value. That is, cover layer 406 may overlap tread edge 419. Cover layer 406 may extend axially outwardly relative to tread portion 418 in either a tread-over-sidewall or a sidewall-over-tread tire structure. Distance D may include a range utilizing the upper and lower limits of any ranges, or exact values, disclosed herein.

FIG. 4C illustrates a cross-section of a portion of tire 400 including cover layer 406. Tire 400 may be mounted on a rim having a flange 420. As illustrated, cover layer 406 may terminate at or near rim centering ring 414, and radially outwardly of flange 420. Abrasion material may be oriented axially inwardly of at least one of rim centering ring 414 and flange 420.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Gamer, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A tire, comprising:
a sidewall portion including a cushion layer and a cover layer,
wherein the cover layer is oriented axially outwardly of the cushion layer,
wherein the cover layer is bonded to the cushion layer,
wherein the cover layer is formed from a material that contains wax in a concentration of less than 0.03 pph, and
wherein the cushion layer does not contain a wax.

2. The tire of claim 1, wherein the cover layer extends radially past the cushion layer on a radially outward side of cover layer by a distance L1, and wherein the distance L1 is one of about 6.4 mm and about 9.5 mm.

3. The tire of claim 1, wherein the cover layer extends radially past the cushion layer on a radially inward side of the cover layer by a distance L2, and wherein the distance L2 is about 6.4 mm.

4. The tire of claim 1, wherein the cover layer includes a thermoset material.

5. The tire of claim 1, wherein the cover layer is formed from a non-staining polymer material.

6. The tire of claim 1, wherein the cushion layer is formed from a material that contains a staining antiozonant in a concentration of less than 0.03 pph.

7. The tire of claim 1, wherein the cushion layer contains a non-staining polymer material.

8. A tire, comprising:
a sidewall portion including a cushion layer and a cover layer,
wherein the cover layer is oriented axially outwardly of the cushion layer,
wherein the cover layer is bonded to the cushion layer,
wherein the cover layer is a thermoset material, and
wherein the cover layer is formed from a material that contains a staining antiozonant in a concentration of less than 0.015 pph.

9. The tire of claim 8, wherein the cover layer extends radially past the cushion layer on a radially outward side of cover layer by a distance L1, and wherein the distance L1 is one of about 6.4 mm and about 9.5 mm.

10. The tire of claim 8, wherein the cover layer extends radially past the cushion layer on a radially inward side of the cover layer by a distance L2, and wherein the distance L2 is about 6.4 mm.

11. The tire of claim 8, wherein the cover layer is formed from a material that contains wax in a concentration of less than 0.03 pph.

12. The tire of claim 8, wherein the cushion layer contains a non-staining polymer material.

13. A tire, comprising:
a sidewall portion including a cushion layer and a cover layer,
wherein the cover layer is oriented axially outwardly of the cushion layer,
wherein the cover layer is bonded to the cushion layer,
wherein the cover layer is formed from a cover layer compound having a variety of polymers,
wherein at least a portion of the polymers have an ozone resistant backbone, and
wherein the cover layer compound contains a staining antiozonant in a concentration of less than 0.03 pph.

14. The tire of claim 13, wherein between about 40% and about 60% of the polymers have an ozone resistant backbone, and wherein the cover layer compound contains a staining antiozonant in a concentration of less than 0.015 pph.

15. The tire of claim 13, wherein the cover layer includes a thermoset material.
